(19) United States
(12) Patent Application Publication
(10) Pub. No.: US 2012/0031953 A1
(43) Pub. Date: Feb. 9, 2012

(54) APPARATUS FOR BUMP REFLOW AND METHODS OF FORMING BUMPS USING THE SAME

(75) Inventors: Myeong Soon PARK, Seoul (KR); Taegyeong CHUNG, Suwon-si (KR); Eunchul AHN, Yongin-si (KR); Ulhyoung LEE, Seoul (KR); Sanghee LEE, Yongin-si (KR)

(73) Assignee: Samsung Electronics Co., Ltd, Suwon-si (KR)

(21) Appl. No.: 13/195,313

(22) Filed: Aug. 1, 2011

(30) Foreign Application Priority Data
Aug. 6, 2010 (KR) 10-2010-0075912

(51) Int. Cl. B23K 3/08; B23K 3/04

(52) U.S. Cl. 228/19

(57) ABSTRACT

A method of forming wafer level bump includes forming at least one pre-bump on a first surface of a wafer, and performing a bump reflow process to the pre-bump while the first surface faces downward, such that a bump is formed.

### CROSS-REFERENCE TO RELATED APPLICATIONS

This U.S. non-provisional patent application claims priority under 35 U.S.C. §119 from Korean Patent Application No. 10-2010-0075912, filed on Aug. 6, 2010, the entire contents of which are hereby incorporated by reference in its entirety.

### BACKGROUND OF THE INVENTION

1. Field of the Invention

The present disclosure herein relates to an apparatus for bump reflow and methods for forming bumps using the same, and more particularly, to an apparatus for wafer level bump reflow and methods for forming wafer level bumps using the same.

2. Description of the Related Art

Recently, a demand for flip chip packages is increasing and technology of the flip chip packages is being further developed as performance of semiconductor devices and systems relevant to the semiconductor devices becomes highly advanced. In particular, as the design rule is shrunken, intervals of pads are being reduced and the wire bonding process has reached as it can go. To overcome these limitations, the demand for flip chip technology is being on the rise.

In the flip chip technology, a sufficient distance between a printed circuit board (PCB) and a die (semiconductor chip) is required to secure an underfill, and a solder of great volume is required to achieve sufficient physical and electrical contact. Therefore, an effective approach to secure the underfill and to achieve a sufficient physical and electrical contact is desired.

### SUMMARY OF THE INVENTION

Accordingly, embodiments of the present general inventive concept provide apparatus for wafer level bump reflow capable of forming a solder bump of which volume is great enough to provide a sufficient underfill gap during a packaging process.

Embodiments of the inventive concept also provide methods for forming bumps using apparatus for wafer level bump reflow capable of forming a solder bump of which volume is great enough to provide a sufficient underfill gap during a packaging process.

Additional features, utilities, and advantages of the present general inventive concept will be set forth in part in the description which follows and, in part, will be obvious from the description, or may be learned by practice of the general inventive concept.

Embodiments of the present general inventive concept provide methods of forming a wafer level bump. The methods include forming at least one pre-bump on a first surface of a wafer, and performing a bump reflow process with respect to the wafer to form a bump while the first surface of the wafer faces downward.

In some embodiments, the bump may be formed in elliptical shape having a major axis perpendicular to the first surface of the wafer.

In other embodiments, the bump reflow process may be a process in which heat is applied to a second surface of the wafer opposite to the first surface.

In still other embodiment, the pre-bump may be solder material containing copper.

Other embodiments of the present general inventive concept provide an apparatus for wafer level bump reflow. The apparatus include a reflow region where a wafer having at least one pre-bump on a first surface is disposed with the first surface facing downward and bump reflow process is performed with respect to the wafer to form at least one bump.

In some embodiments, the reflow region may include a turret type reflow part having at least one wafer stage on which the wafer is disposed with the first surface facing downward, and a heating part applying heat to a second surface of the wafer opposite to the first surface. The turret reflow part may be rotated in certain direction. The apparatus may further include a wafer guide provided in the wafer stage to restrain movement of the wafer on the wafer stage. The wafer guide may be in contact with at least three point of the wafer to restrain the movement of the wafer. The wafer stage may have a concave shape with a depth larger than a height of the pre-bump. The wafer stage may have a hole shape bored through the turret type reflow part. The heating part may be configured to be moved up and down.

In other embodiments, the reflow region may include a conveyer type reflow part to move the wafer, and the heating part to apply heat to the second surface of the wafer. The wafer may be received at a jig with the first surface facing downward while being spaced apart from the conveyer type reflow, and the jig is mounted on the conveyer type reflow part. The jig may include a receiving part to contain the wafer, a support plate to mount the jig on the conveyer type reflow part, and a support part connecting the support plate and the receiving part to support the receiving part. The receiving part may have a partially opened annular shape with a C-shaped cross section such that the wafer is contained in the receiving part. The receiving part may include a plurality of segments which are spaced apart from each other. The support part may include support columns, a number of the support columns corresponding to a number of the segments of the receiving part. The support part may include at least three support columns.

In still other embodiments, the apparatus may further include a loading part to receive a plurality of wafers with facing the first surfaces upward and delivering the wafer to the reflow region, and an unloading part to unload the wafer on which the bump was formed in the bump reflow process from the reflow region and to receive the wafer with the first surface facing upward. The apparatus may further include a first transfer delivering the wafer from the loading part to the reflow region with the first surface facing downward, and a second transfer delivering the wafer from the reflow region to the unloading part with the first surface facing upward.

Other embodiments of the present general inventive concept provide a method of forming a wafer level bump, including forming at least one pre-bump on a first surface of a wafer, positioning the wafer to have the at least one pre-bump facing downward, and performing a bump reflow process to form at least one bump on the first surface of the wafer from the at least one pre-bump.

In some embodiments, the performing of the bump reflow process may include heating the at least one pre-bump to form the at least one bump on the first surface of the wafer. The heating may include applying heat to a second surface of a wafer located on an opposite side from the first surface of the wafer.

In some embodiments, the positioning of the wafer may include positioning the wafer to align the major axis of the at least one bump to the first surface of the wafer.

In some embodiments, the forming the at least one pre-bump may include forming the at least one pre-bump to face upward on the first surface of the wafer.

In some embodiments, a shape of the at least one pre-bump may be a t-shape.

In some embodiments, a shape of the at least one bump may be a round shape.

In some embodiments, gravity may shape the pre-bump to flow away from the wafer to form the at least one bump during the bump reflow process.

In some embodiments, the method may further include performing a deflux process with respect to the at least one bump of the wafer.

Other embodiments of the present general inventive concept provide an apparatus for wafer level bump reflow, including a reflow part to receive a wafer having at least one pre-bump on a first surface of the wafer and to hold the wafer to have the first surface downward, and a heating part to heat the at least one pre-bump to form at least one bump on the first surface.

In some embodiments, the heating part may heat the at least one pre-bump by applying heat to a second surface of a wafer located on an opposite side from the first surface of the wafer.

In some embodiments, the apparatus may further include a first transfer unit to deliver the wafer from a loading part containing wafers having pre-bumps to the reflow part. The first transfer unit may be a first robot arm having a first blade shaped end to carry the wafer and configured to be rotated by the first robot arm to flip the wafer.

In some embodiments, the apparatus may further include a second transfer unit to deliver the wafer from the reflow part to an unloading part to unload the wafer after the at least one bump is formed. The second transfer unit may be a second robot arm having a second blade shaped end to carry the wafer and configured to be rotated by the second robot arm to flip the wafer.

In some embodiments, the reflow part may be a turret type including at least one wafer stage to receive the wafer with the first surface facing downward toward the gravity. The turret type may be configured to rotate in one direction to move the wafer in a circular motion. The at least one wafer stage may have a concave shape with a depth deeper than a height of the wafer such that the pre-bump does not contact a bottom of the concave shape when the wafer is received at the at least one wafer stage. The at least one wafer stage may have a hole shape bored through the turret type.

In some embodiments, the reflow part may be a conveyer type having at least one jig mounted thereto and configured to move the at least one jig, the at least one jig being configured to receive the wafer with the first surface facing downward toward the gravity. The at least one jig may include a receiving part configured to receive the wafer with the first surface facing downward toward the gravity, a support plate to mount the receiving part on the conveyer type, a support part to connect the support plate and the receiving part to support the receiving part. The receiving part may have a partially opened annular shape with a C-shaped cross section to receive the wafer through the partially opened area. The receiving part may include a plurality of segments which are spaced apart from each other and a partially opened area to receive the wafer. The support part may include a plurality of support columns corresponding to the segments of the receiving part.

Other embodiments of the present general inventive concept provide system for wafer level bump reflow, the system including a wafer including a first surface having at least one pre-bump, and a second surface on an opposite side from the first surface, and a reflow part to hold the wafer to have the first surface downward during a bump reflow process to form at least one bump on the first surface from the at least one pre-bump.

In some embodiment, the system may further include a heating part to heat the at least one pre-bump to form the at least one bump on the first surface during the bump reflow process. The heating part may heat the at least one pre-bump by applying heat to the second surface of a wafer located on an opposite side from the first surface of the wafer.

In some embodiment, the system may further include a first transfer unit to deliver the wafer from a loading part containing wafers having pre-bumps to the reflow part. The first transfer unit may be a first robot arm having a first blade shaped end to carry the wafer and configured to be rotated by the first robot arm to flip the wafer.

In some embodiment, the system may further include a second transfer unit to deliver the wafer from the reflow part to an unloading part to unload the wafer after the at least one bump is formed. The second transfer unit may be a second robot arm having a second blade shaped end to carry the wafer and configured to be rotated by the second robot arm to flip the wafer.

### BRIEF DESCRIPTION OF THE DRAWINGS

The accompanying drawings are included to provide a further understanding of the inventive concept, and are incorporated in and constitute a part of this specification. These and/or other features, utilities, and advantages of the present general inventive concept will become apparent and more readily appreciated from the following description of the embodiments, taken in conjunction with the accompanying drawings of which:

FIG. 1 is a perspective view illustrating an apparatus for wafer level bump reflow according to an embodiment of the inventive concept;

FIG. 2 is a plan view illustrating a reflow part of an apparatus for wafer level bump reflow according to an embodiment of the inventive concept;

FIGS. 3A and 33 are cross-sectional views taken along line I-I′ of FIG. 1, illustrating reflow parts of the apparatus for wafer level bump reflow according to embodiments of the inventive concept;

FIG. 4 is a perspective view illustrating an apparatus for wafer level bump reflow according to another embodiment of the inventive concept;

FIG. 5 is a cross-sectional view taken along line II-II′ of FIG. 4;

FIGS. 6A and 7A are plan views illustrating jigs of an apparatus for wafer level bump reflow according to other embodiments of the inventive concept, and FIGS. 6B and 7B are front views illustrating the jigs, respectively; and

FIGS. 8 through 11 are cross-sectional views illustrating a method for forming a wafer level bump according to an embodiment of the inventive concept.

### DETAILED DESCRIPTION OF THE PREFERRED EMBODIMENTS

Exemplary embodiments of the inventive concept will be described below in more detail with reference to the accompanying drawings. The embodiments of the present general inventive concept may, however, be embodied in different forms and should not be construed as limited to the embodiments set forth herein. Rather, these embodiments are provided so that this disclosure will be thorough and complete, and will fully convey the scope of the present general inventive concept to those skilled in the art.

Hereinafter, exemplary embodiments of the present general inventive concept will be described in detail with reference to the accompanying drawings.

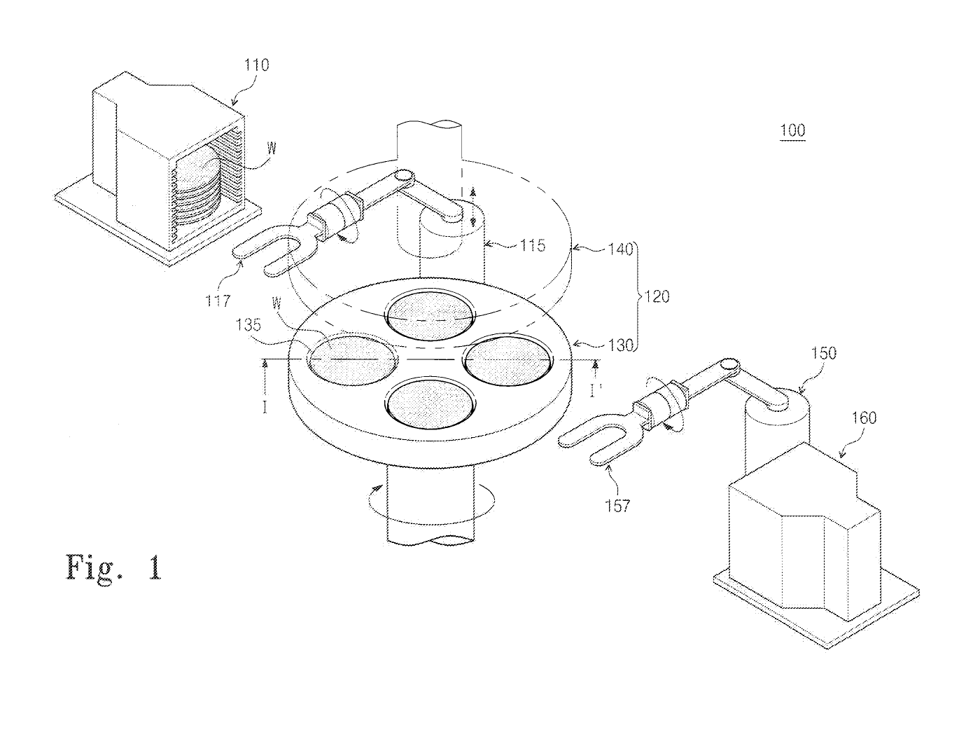

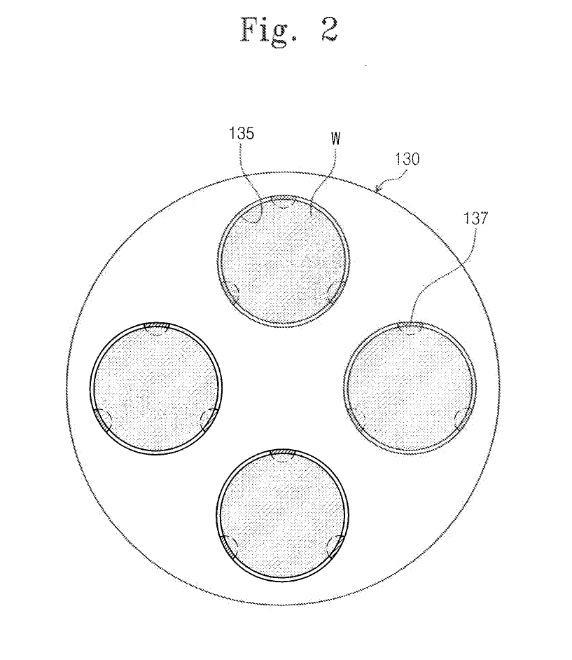

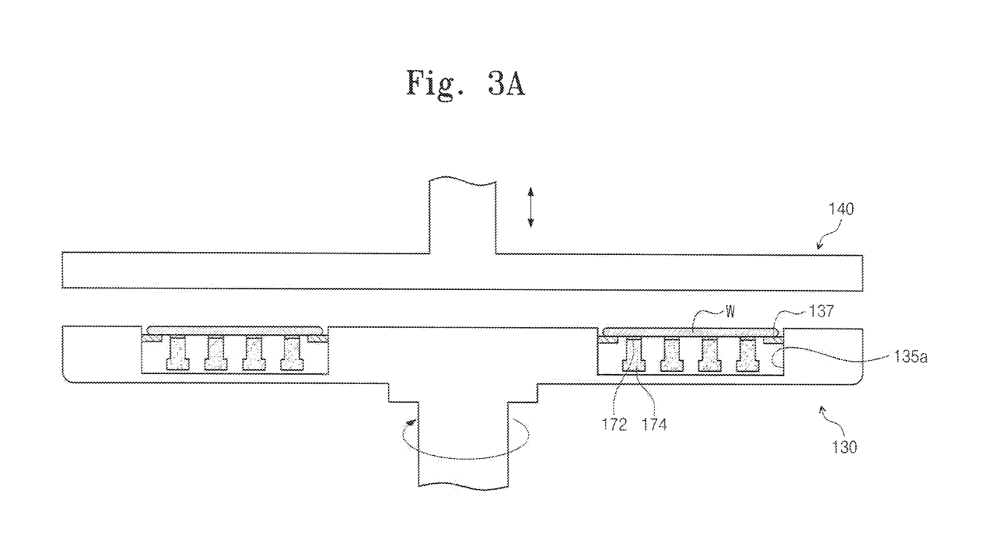

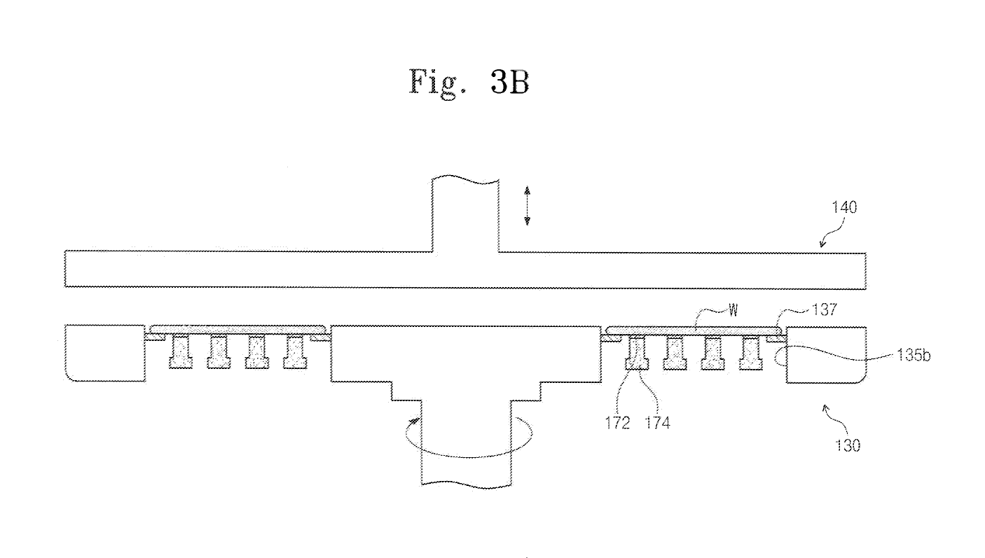

FIG. 1 is a perspective view illustrating an apparatus for wafer level bump reflow according to an embodiment of the present general inventive concept. FIG. 2 is a plan view illustrating a reflow part of an apparatus for wafer level bump reflow according to an embodiment of the present general inventive concept. FIGS. 3A and 3B are cross-sectional views taken along line ‘I-I’ of FIG. 1, illustrating reflow parts of the apparatus for wafer level bump reflow according to embodiments of the present general inventive concept.

Referring to FIG. 1 through FIG. 3B, an apparatus for wafer level bump reflow 100 includes a loading part 110, a first transfer 115, a reflow region 120, a second transfer 150, and an unloading part 160.

A wafer W has an active surface on one side and a rear surface opposite to the active surface on the other side. A plurality of pads 172 may be disposed on the active surface of the wafer W. A plurality of pre-bumps 174 may be disposed on the pads 172, respectively.

The loading part 110 may provide a space to receive a plurality of wafers W in order to deliver the wafer W to the reflow region 120. A plurality of wafers W may be received in the loading part 110 with the active surface facing upward. At the loading part 110, a flux coating process may be performed with respect to the pre-bumps 174 of the wafer W. According to one embodiment, several loading parts 110 may be provided.

The first transfer 115 may deliver the wafer W from the loading part 110 to the reflow region 120 with the active surface facing downward. The first transfer 115 may be a robot arm having a blade shaped end 117. The first transfer 115 can rotate the blade shaped end 117 in order to turn the wafer W to have the active surface facing downward. The blade shaped end 117 of the first transfer 115 may include two layered blades or an absorber on a surface of the blade in order to deliver and to turn the wafer W.

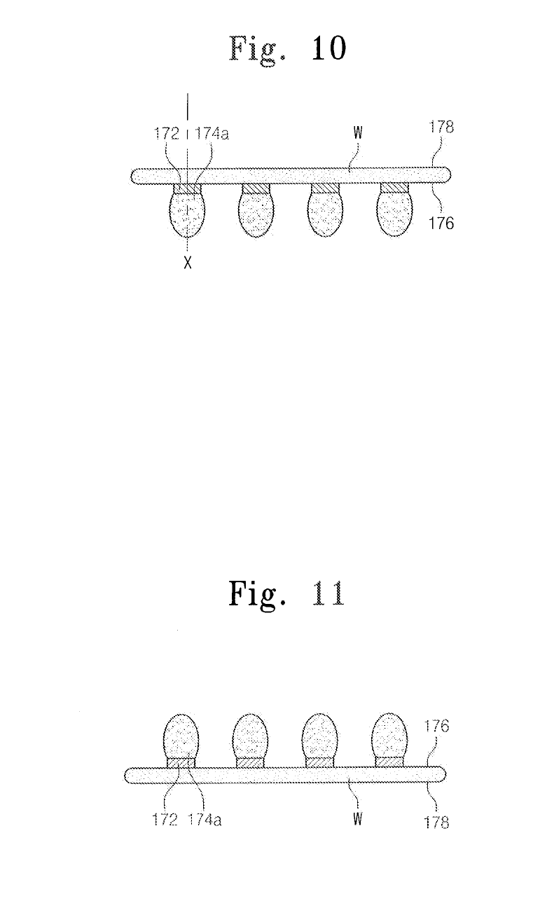

The reflow region 120 may include a turret type reflow part 130 and a heating part 140. The turret type reflow part 130 may have at least one wafer stage 135 where the wafer W is mounted with the active surface facing downward. The heating part 140 may be disposed to apply heat to the wafer W on the wafer stage 135. In this case, with the wafer W facing downward, the heating part 140 is disposed to apply heat to the rear surface of the wafer W. The heating part 140 may include a plurality of sectors such that each of the sectors separately applies heat to the wafer W. The turret type reflow part 130 may be rotated in a certain direction. As the turret type reflow part 130 is rotating, the wafer W may be applied with heat at several temperatures by the heating part 140. By the bump reflow process applying heat to the wafer W at the reflow region 120, the pre-bumps 174 disposed on the active surface of the wafer W can be transform into bumps 174a of FIG. 10 or 11.

In one embodiment, several wafer stages 135 may be provided. The wafer stage 135 may have either a concave shape 135a having a depth larger than the height of the pre-bump 174 or a hole shape 135b bored through the turret type reflow part 130. A wafer guide 137 may be provided in the wafer stage 135. The wafer guide 137 may restrain movement of the wafer W disposed on the wafer stage 135. Further, the wafer guide 137 may provide a support for the wafer W such that the pre-bump 174 does not contact the bottom of the wafer stage 135 of the concave shape 135a. Also, the wafer guide 137 may be in contact with the entire edge of the wafer W or at least three points of the edge of the wafer W, as illustrated in FIG. 2.

The heating part 140 can be moved up and down. The first transfer 115 can put the wafer W on the wafer stage 130 of the turret type reflow part 130 while the heating part 140 is moved up, and heat can be applied to the wafer W to perform the bump reflow process while the heating part 140 is moved down.

The second transfer 150 may deliver the wafer W from the reflow region 120 to the unloading part 160 with the active surface facing downward. The second transfer 150 may be a robot arm having a blade shaped end 157 similar to the components of the first transfer 115. The second transfer 150 can rotate the blade shaped end 157 in order to turn the wafer W to have the active surface facing upward. The blade shaped end 157 may include two layered blades or an absorber on a surface of the blade to deliver and to turn the wafer W.

The unloading part 160 may provide a space to receive a plurality of wafers W which have bumps formed in the bump reflow process at the reflow region 120 and are unloaded from the reflow region 120. The wafer W may be received at the unloading part 160 with the active region facing upward. A deflux process may be performed with respect to the bumps of the wafer W at the unloading part 160. In one embodiment, several unloading parts 160 may be provided.

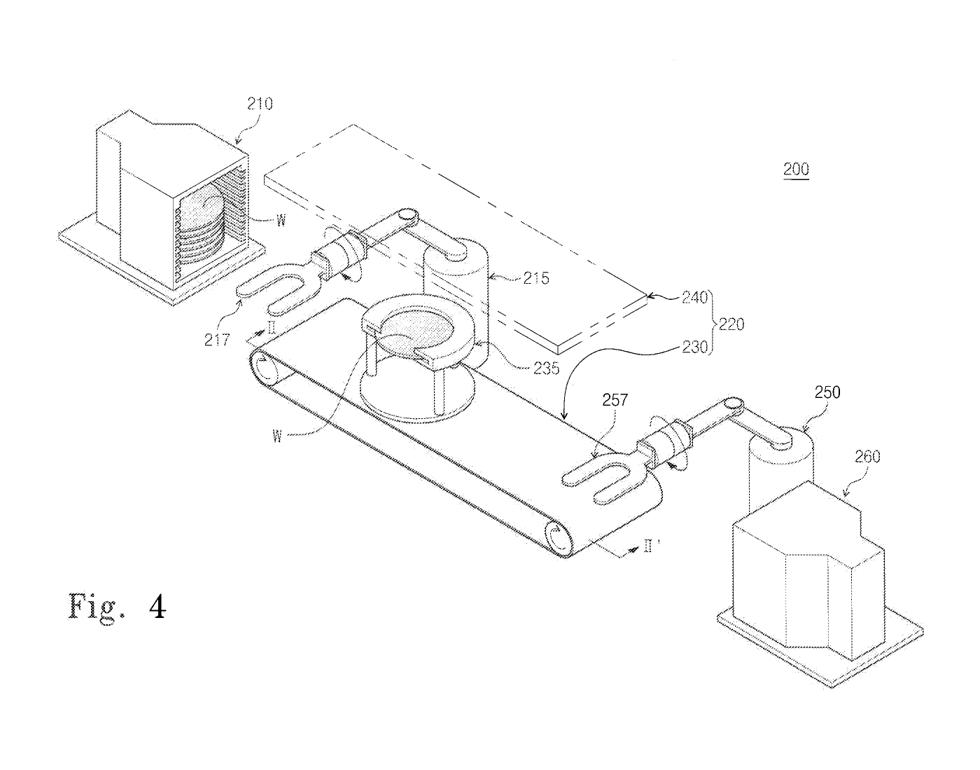

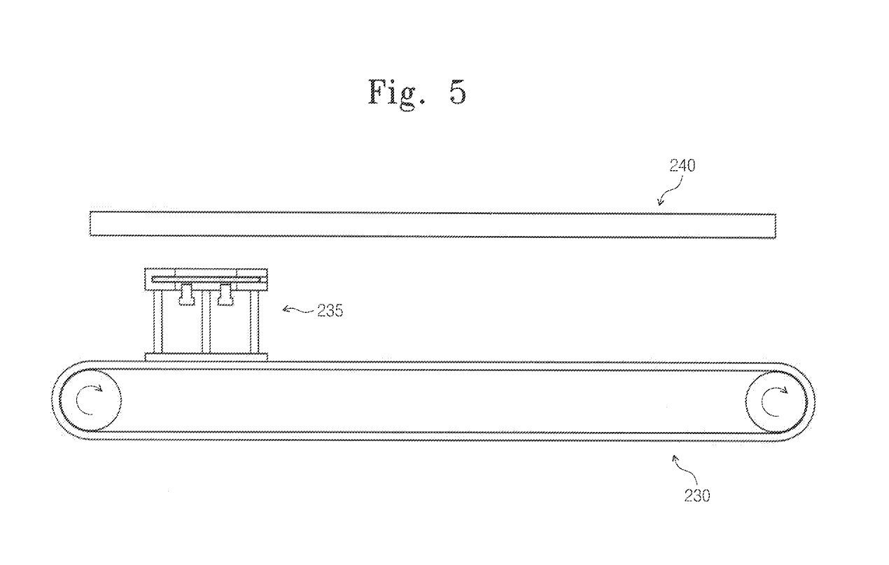

FIG. 4 is a perspective view illustrating an apparatus for wafer level bump reflow according to another embodiment of the present general inventive concept. FIG. 5 is a cross-sectional view taken along line ‘II-II’ of FIG. 4. FIGS. 6A and 7A are plan views illustrating jigs of an apparatus for wafer level bump reflow according to other embodiments of the present general inventive concept, and FIGS. 6B and 7B are front views illustrating the jigs, respectively.

Referring to FIG. 4 through FIG. 7B, an apparatus for wafer level bump reflow 200 may include a loading part 210, a first transfer 215, a reflow region 220, a second transfer 250 and an unloading part 260.

A wafer W has an active surface on one side and a rear surface opposite to the active surface on the other side. A plurality of pads 172 may be disposed on the active surface of the wafer W. A plurality of pre-bumps 174 may be disposed on the pads 172, respectively.

The loading part 210 may provide a space to receive a plurality of wafers W in order to load the wafers W to the reflow region 220. The wafer W may be received at the loading part 210 with the active surface facing upward. A flux coating process with respect to the pre-bumps 174 may be performed at the loading part 210. According to one embodiment, several loading parts 210 may be provided.

The first transfer 215 may deliver the wafer W from the loading part 210 to the reflow region 220 with the active surface facing downward. The first transfer 215 may be a robot arm having a blade shaped end 217. The first transfer 215 can rotate the blade shaped end 217 to turn the wafer W to have the active surface of the wafer facing downward. The blade shaped end 217 may include two layered blades or an absorber on a surface of the blade to deliver and turn the wafer W.

The reflow region 220 may include a conveyer type reflow part 230 and a heating part 240. A jig 235 may be mounted on the conveyer type reflow part 230. The jig 235 may support the wafer W such that the wafer W is received at the jig 235 away from the conveyer type reflow part 230 with the active surface facing downward. The heating part 240 may be disposed to apply heat to the wafer W at the jig 235. In this case, with the wafer W facing downward, the heating part 240 is disposed to apply heat to the rear surface of the wafer W. The heating part 240 may have a plurality of sectors divided in one direction in which wafer W is moved, such that each of the sectors separately applies heat to the wafer W at the reflow region 220. The pre-bumps 174 disposed on the active surface of the wafer W may be transformed to bumps 174a of FIG. 10 or 11 in the reflow process at the reflow region 220.

The jig 235 may include a receiving part 235t, a support plate 235b and support part 235s. The receiving part 235t may receive the wafer W with the active surface facing downward. The support plate 235b may support the jig 235 such that the jig 235 can be mounted on the conveyer type reflow part 230 stably. The support part 235s may connect the support plate 235b to the receiving part 235t and may support the receiving part 235t. The support part 235s may be at least three support columns which are higher than the pre-bump 174 in height.

The jig 235 may be a removable jig 235A or a mount jig 2356. The removable jig 235A may include the receiving part 235t which is partially opened annular type with C-shaped cross section such that the wafer can be received via the partially opened area. The receiving part 235t of the removable jig 235A may be used without being attached on the conveyer type reflow part 230 because the receiving part 235t is formed into one body. Thus the apparatus for wafer level bump reflow 200 may include a jig loading part (not shown) and a jig unloading part (not shown) such that the removable jig 235A can be loaded on or unloaded (removed) from the conveyer type reflow part 230.

The mount jig 235B may include a receiving part 235ta which is a partially opened annular type such that the wafer can be received via the partially opened area. The receiving part 235ta may be formed of a plurality of segments which have C-shaped cross section and are separated from each other to form an annular shape. For example, the receiving part 235ta in the example shown in FIG. 7A has three segments having C-shaped cross section. The support part 235sa of the mount jig 235B may include a plurality of support columns 235sa. The number of the support columns 235sa may correspond to the number of the segments of the receiving part 235ta. Since the receiving part 235ta of the mount jig 235B is formed of the plurality of segments, the mount jig 235B may be used as being mounted or attached on the conveyer type reflow part 230. If the support plate 235ba of the mount jig 235B includes a flexible material, the receiving part 235ta may be continuously used while being mounted or attached on the conveyer type reflow part 230 via the support columns 235sa and the support plate 235ba because the segments of the receiving part 235ta are connected to the support plate 235ba through the support columns 235sa.

The second transfer 250 may unload the wafer W which is disposed with the active surface facing downward at the reflow region 220. The second transfer 250 may unload the wafer W with the active surface facing upward. The second transfer 250 may be a robot arm with a blade shaped end 257. The second transfer 250 may rotate the blade shaped end 257 to turn the wafer W to have the active surface facing upward. The blade shaped end 257 may include two layered blades or an absorber on a surface of the blade to deliver and to turn the wafer W.

The unloading part 260 may provide a space to receive a plurality of wafers W which are unloaded from the reflow region 220 and have the bumps formed in the bump reflow process at the reflow region 220. The wafer W may be received to the unloading part 260 with the active surface facing upward. A deflux process may be performed with respect to the bumps of the wafer W at the unloading part 260. In one embodiment, several unloading parts 260 may be provided.

Using the apparatus according to embodiments of the present general inventive concept, the pre-bump disposed on the active surface of the wafer faces downward while the bump reflow process is performed with respect to the wafer. Therefore, the bump on the active surface is prevented from collapsing due to the gravity during the bump reflow process while preventing solder material from falling down on the active surface of the wafer. The embodiment of the present general inventive concept can provide a semiconductor device having a solder bumper which is large enough to provide a sufficient underfill gap and has high reliability. In addition, the solder bump may be tall enough to provide a sufficient underfill gap in the packaging process. Further, fine pitch between the solder bumps may be achieved to provide a semiconductor device which has improved integrity while having a solder bump with a great volume enough to provide sufficient underfill gap and improved integrity.

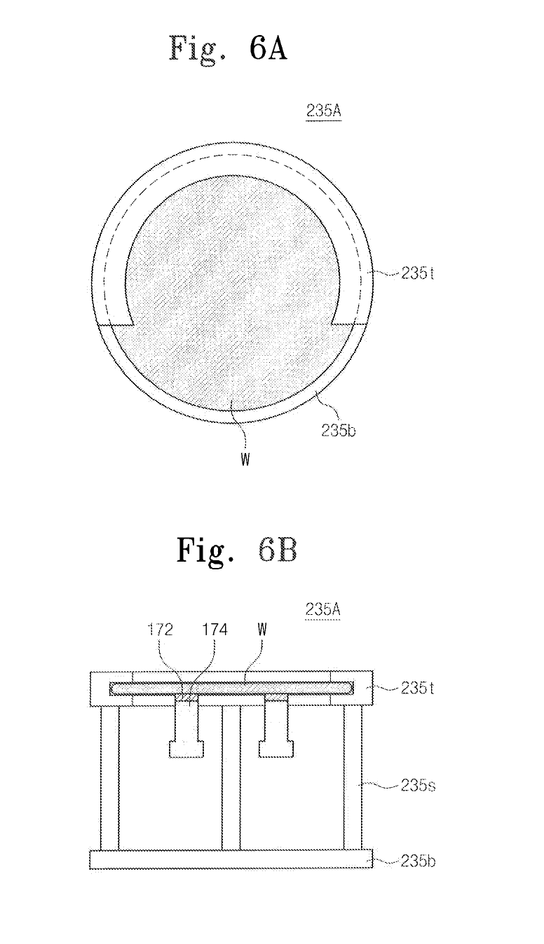

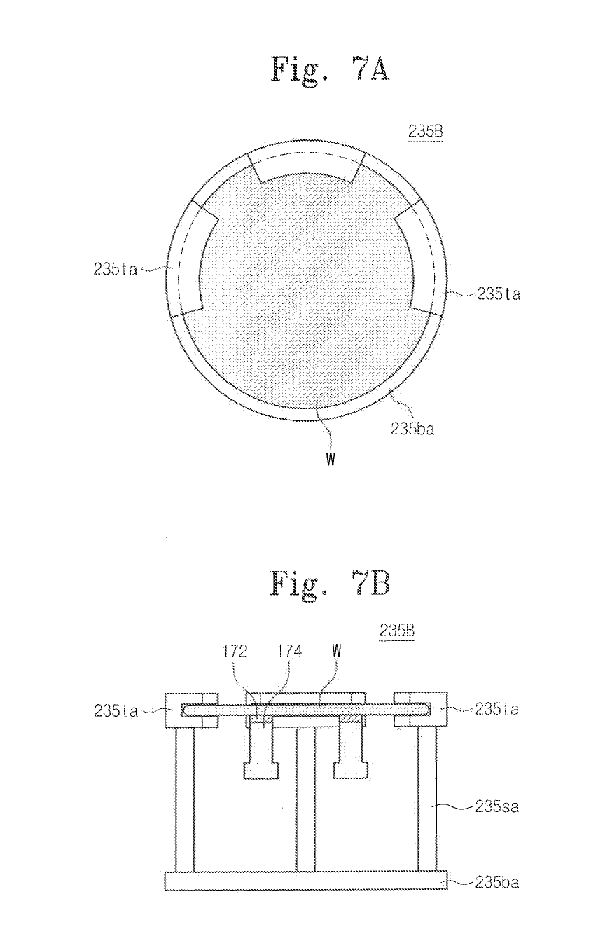

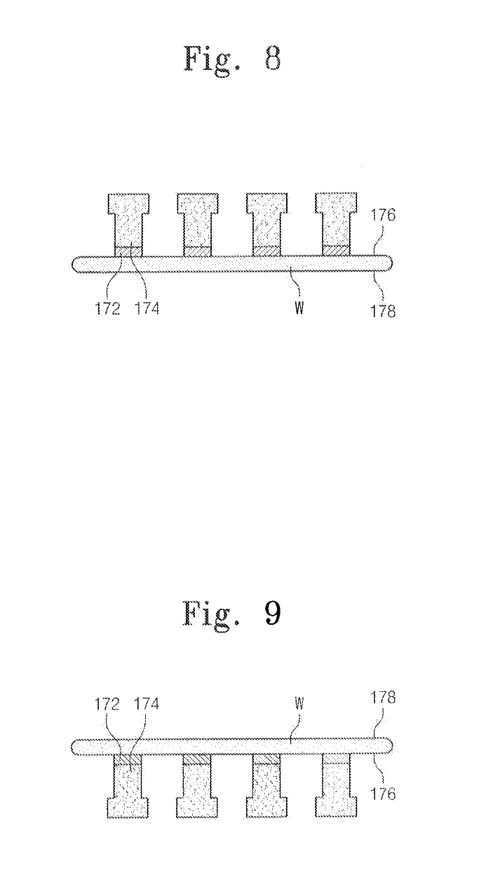

FIGS. 8 through 11 are cross-sectional views illustrating a method for forming a wafer level bump according to an embodiment of the present general inventive concept.

Referring to FIG. 8, a pre-bump 174 is formed on each pad 172 of a wafer W which has a plurality of the pads 172 on an active surface 176. The pre-bump 174 may include a solder material containing copper.

Referring to FIGS. 9 and 10, the wafer W is flipped such that the active surface 176 is facing downward, as illustrated in FIG. 9. For example, the active surface 176 may face toward a direction of the gravitational force. Then, a bump 174a is formed in a bump reflow process in which heat is applied to a rear surface 178 being opposite to the active surface 176 of the wafer W, as illustrated in FIG. 10. The bump 174a may be formed into elliptical shape which has its major axis X perpendicular to the active surface 176 of the wafer W. For example, the wafer W may be disposed with respect to gravity such that the bump 174a may be formed to have its major axis X perpendicular to the active surface 176 of the wafer W.

Referring to FIG. 11, the wafer W with the bump 174a is flipped such that the active surface 176 faces upward. The wafer W may be divided into a plurality of chips using a cutting process such as a sawing thereby forming discrete semiconductor devices or semiconductor packages.

Since the bump reflow process is performed while the pre-bump on the active surface 176 of the wafer is facing downward, the solder bump formed in the method according to the embodiment of the present general inventive concept is tall, and fine pitch between the solder bumps is achieved, such that a semiconductor device can be provide with improved integrity while having the solder bump tall enough to provide a sufficient underfill gap.

The memory device or memory system according to embodiments of the present general inventive concept may be formed into a variety of packages. For example, the nonvolatile memory system can be mounted as a PoP (Package on Package), a BGAs (Ball grid arrays), a CSPs (Chip Scale Packages), a PDIP (Plastic Dual In-line Package), a Die in Waffle Pack, a Die in Wafer Form, a COB (Chip On Board), a CERDIP (Ceramic Dual In-line Package), a MQFP (Plastic Metric Quad Flat Pack), a TQFP (Thin Quad Flat Pack), a SOIC (Small Outline), a SSOP (Shrink Small Outline Package), a TSOP (Thin Small Outline), a TQFP (Thin Quad Flat Pack), a SIP (System In Package), a MCP (Multi Chip Package), a WFP (Wafer-level Fabricated Package), a WSP (Wafer-level Processed Stack Package and etc.

According to embodiments of the present general inventive concept, the pre-bump disposed on the active surface of the wafer is facing downward while the bump reflow process is performed with respect to the wafer. Therefore, the bump is prevented from collapsing in the bump reflow process. The embodiment of the present general inventive concept can provide a semiconductor device having a solder bump which is large enough to provide a sufficient underfill gap. In addition, the solder material does not fall down on the active surface of the wafer during the bump reflow process, such that the semiconductor device can be improved in reliability with the sufficient underfill gap in a packaging process.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents. Thus, to the maximum extent allowed by law, the scope of the present general inventive concept is to be determined by the broadest permissible interpretation of the following claims and their equivalents, and shall not be restricted or limited by the foregoing detailed description.

What is claimed is:

1-2. (canceled)

3. An apparatus for wafer level bump reflow, comprising:
a reflow region where a wafer having at least one pre-bump on a first surface is disposed with the first surface facing downward and a bump reflow process is performed with respect to the wafer to form a bump.

4. The apparatus of claim 3, wherein the reflow region comprises:
a turret type reflow part having at least one wafer stage where the wafer is disposed with the first surface facing downward; and
a heating part applying heat to a second surface of the wafer opposite to the first surface.

5. The apparatus of claim 4, wherein the turret reflow part is rotated in one direction.

6. The apparatus of claim 4, further comprising:
a wafer guide provided in the wafer stage to restrain movement of the wafer on the wafer stage.

7. The apparatus of claim 4, wherein the wafer stage has a concave shape with a depth larger than a height of the pre-bump.

8. The apparatus of claim 4, wherein the wafer stage has a hole shape bored through the turret type reflow part.

9. The apparatus of claim 4, wherein the heating part is configured to be moved up and down.

10. The apparatus of claim 3, wherein the reflow region comprises:
a conveyer type reflow part to move the wafer; and
a heating part to apply heat to the second surface of the wafer,
wherein the wafer is received at a jig with the first surface facing downward while being spaced apart from the conveyer type reflow part, and the jig is mounted on the conveyer type reflow part.

11. The apparatus of claim 10, wherein the jig comprises:
a receiving part to contain the wafer;
a support plate to mount the jig on the conveyer type reflow part; and
a support part connecting the support plate and the receiving part to support the receiving part.

12. The apparatus of claim 11, wherein the receiving part has a partially opened annular shape with a C-shaped cross section such that the wafer is contained in the receiving part.

13. The apparatus of claim 12, wherein the receiving part comprises a plurality of segments which are spaced apart from each other.

14. The apparatus of claim 13, wherein the support part comprises support columns, a number of the support columns corresponding to a number of the segments of the receiving part.

15. The apparatus of claim 3, further comprising:
a loading part to receive a plurality of wafers with the first surface facing upward and delivering the wafer to the reflow region; and
an unloading part to unload the wafer on which the bump was formed in the bump reflow process from the reflow region and to receive the wafer with the first surface facing upward.

16. A system for wafer level bump reflow, the system comprising:
a wafer including:
a first surface having at least one pre-bump, and
a second surface on an opposite side from the first surface; and
a reflow part to hold the wafer to have the first surface downward during a bump reflow process to form at least one bump on the first surface from the at least one pre-bump.

17. The system of claim 16, further comprising:
a heating part to heat the at least one pre-bump to form the at least one bump on the first surface during the bump reflow process.

18. The system of claim 17, wherein the heating part heats the at least one pre-bump by applying heat to the second surface of a wafer located on an opposite side from the first surface of the wafer.

19. The system of claim 16, further comprising:
a first transfer unit to deliver the wafer from a loading part containing wafers having pre-bumps to the reflow part,
wherein the first transfer unit is a first robot arm having a first blade shaped end to carry the wafer and configured to be rotated by the first robot arm to flip the wafer.

20. The system of claim 16, further comprising:
a second transfer unit to deliver the wafer from the reflow part to an unloading part to unload the wafer after the at least one bump is formed,
wherein the second transfer unit is a second robot arm having a second blade shaped end to carry the wafer and configured to be rotated by the second robot arm to flip the wafer.
